(19) United States
(12) Patent Application Publication
(10) Pub. No.: US 2026/0183989 A1
(43) Pub. Date: Jul. 2, 2026

(54) HEATING REACTION METHOD AND HEATING APPARATUS

(71) Applicant: INDUSTRIAL TECHNOLOGY RESEARCH INSTITUTE, Hsinchu (TW)

(72) Inventors: Cheng-Han HSIEH, Changhua City (TW); Chih-Jen CHANG, Toufen City (TW); Kung-Hsun HUANG, Hsinchu City (TW); Chih-Ming HU, Hsinchu City (TW)

(73) Assignee: INDUSTRIAL TECHNOLOGY RESEARCH INSTITUTE, Hsinchu (TW)

(21) Appl. No.: 19/400,496

(22) Filed: Nov. 25, 2025

(30) Foreign Application Priority Data
Dec. 31, 2024 (TW) 113151689
Dec. 31, 2024 (TW) 113214510

(51) Int. Cl. B29B 17/04; B09B 3/50; H05B 6/80

(52) U.S. Cl. CPC B29B 17/04; B09B 3/50; B29B 2017/0496; H05B 6/80

(57) ABSTRACT

This disclosure relates to a heating reaction method including the following steps: placing an object into a barrel of a twin-screw extruder; transporting the object from a feeding section of the barrel to a heating section of the barrel using a twin-screw of the twin-screw extruder; applying microwaves to the object within the heating section using a microwave generation device for heating and decomposing the object into at least one product; and discharging the at least one product from the barrel using the twin-screw.

### CROSS-REFERENCE TO RELATED APPLICATIONS

This non-provisional application claims priority under 35 U.S.C. § 119 (a) on Patent Application No(s). 113151689 filed in Taiwan on Dec. 31, 2024 and Patent Application No(s). 113214510 filed in Taiwan on Dec. 31, 2024, the entire contents of which are hereby incorporated by reference.

### TECHNICAL FIELD

The present disclosure relates to a heating reaction method and heating apparatus utilizing microwave heating.

### BACKGROUND

With technological advancements, composite materials are frequently used as parts of goods in various fields. Additionally, waste containing composite materials is often generated during goods manufacturing.

However, when these goods or waste containing composite materials need to be recycled, the composite materials are often difficult to decompose into reusable raw materials, limiting their recycling value. Therefore, developing a heating reaction method and a heating apparatus capable of efficiently and thermally decomposing composite materials has become a key topic in the field.

### SUMMARY

According to one embodiment of the present disclosure, a heating reaction method includes the following steps: placing an object into a barrel of a twin-screw extruder; transporting the object from a feeding section of the barrel to a heating section of the barrel using a twin-screw of the twin-screw extruder; applying microwaves to the object within the heating section using a microwave generation device for heating and decomposing the object into at least one product; and discharging the at least one product from the barrel using the twin-screw.

According to another embodiment of the present disclosure, a heating apparatus includes a twin-screw extruder and a microwave generation device. The twin-screw extruder includes a barrel and a twin-screw. The barrel has at least one feeding section, at least one heating section and at least one discharging section sequentially arranged. The at least one feeding section, the at least one heating section and the at least one discharging section are in space connection with one another and form a transportation space. The twin-screw is rotatably disposed in the transportation space. The microwave generation device includes a waveguide and a microwave heater. The waveguide is directly disposed on the at least one heating section of the barrel. The microwave heater is directly disposed on a side of the waveguide farther from the barrel, and the microwave heater applies microwaves to the at least one heating section through the waveguide.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a schematic view of a heating apparatus according to one embodiment of the present disclosure;

FIG. 2 is a partial and enlarged view of the heating apparatus in FIG. 1;

FIG. 3 and FIG. 4 are flow charts of a heating reaction method according to one embodiment of the present disclosure; and

FIG. 5 is a line chart comparing heating rates of a heating reaction method according to one embodiment of the present disclosure and a conventional electric heating method.

### DETAILED DESCRIPTION

For purposes of explanation, one or more specific embodiments are given to provide a thorough understanding of the invention, and which are described in sufficient detail to enable one skilled in the art to practice the described embodiments. It should be understood that the following descriptions are not intended to limit the embodiments to one specific embodiment. On the contrary, it is intended to cover alternatives, modifications, and equivalents as can be included within the spirit and scope of the described embodiments as defined by the appended claims.

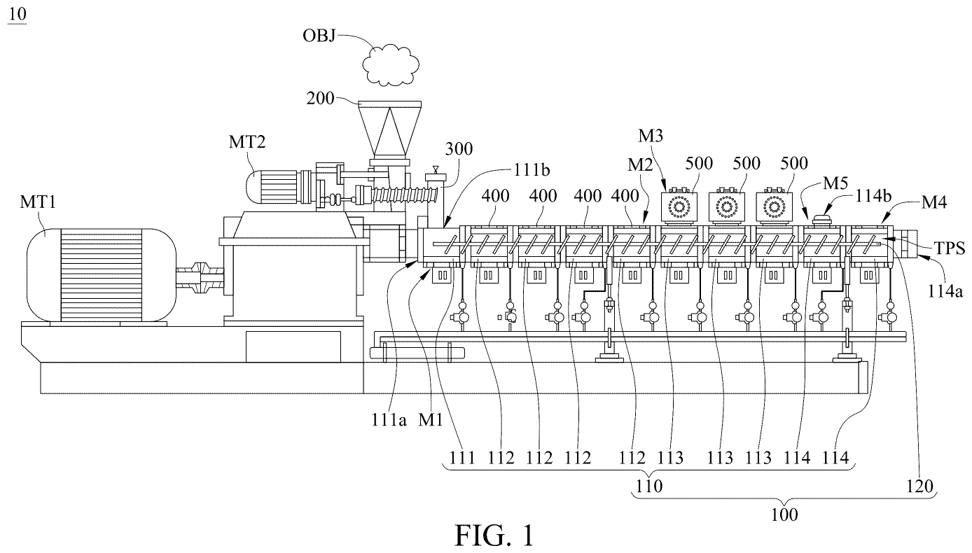

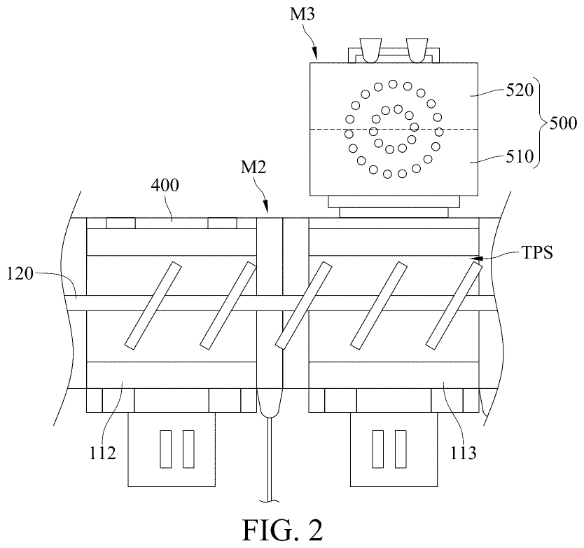

In the following, a heating apparatus 10 of one embodiment of the present disclosure is illustrated. Please refer to FIG. 1 to FIG. 2, where FIG. 1 is a schematic view of a heating apparatus according to one embodiment of the present disclosure, and FIG. 2 is a partial and enlarged view of the heating apparatus in FIG. 1.

A heating apparatus 10 provided in this embodiment may be, for example, an apparatus that can perform a continuous high-temperature reaction on an object OBJ to thermally decompose the object OBJ into at least one product (not shown), wherein the object OBJ may be, for example, an organic material being present in solid form or fluid form, and the at least one product may be, for example, small molecules or oligomer materials being present in solid form, fluid form or gaseous form. Please note that in the description of the present disclosure, an article in solid form refers to an article having a fixed shape and volume at room temperature, an article in fluid form refers to an article that is capable of flowing at room temperature, including liquids and substances having a viscous or melted appearance, and an article in gaseous form refers to an article that is in a gaseous state at room temperature and capable of expanding to fill its container. The heating apparatus 10 may include a twin-screw extruder 100, a feeding hopper 200, an intake pipe 300, a plurality of preheaters 400, and a plurality of microwave generation devices 500.

The twin-screw extruder 100 includes a barrel 110 and a twin-screw 120. The barrel 110 may have a feeding section 111, a plurality of pre-heating sections 112, a plurality heating sections 113, and a plurality of discharging sections 114 that are sequentially arranged.

The feeding section 111 may include a feeding port 111a and a gas inlet 111b. The feeding port 111a may be positioned farther from the pre-heating sections 112 and the heating sections 113 than the gas inlet 111b.

The pre-heating sections 112 can be detachably assembled with each other, and the pre-heating sections 112 are detachably disposed between the feeding section 111 and the heating sections 113.

The heating sections 113 can be detachably assembled with each other, and the heating sections 113 are detachably disposed between the feeding section 111 and the discharging sections 114. In this embodiment, the heating sections 113 are detachably and indirectly disposed to the feeding section 111 via the pre-heating sections 112. However, the present disclosure is not limited thereto. In some embodiments of the present disclosure, the pre-heating sections may be omitted, and the heating sections may be detachably and directly disposed to the feeding section.

The discharging sections 114 can be detachably assembled with each other, and the discharging sections 114 are detachably disposed on a side of the heating sections 113 farther from the feeding section 111 and the pre-heating sections 112. One discharging section 114 may have a discharging port 114a, while another discharging section 114 may have a gas outlet 114b. The discharging port 114a may be positioned farther from the heating sections 113 than the gas outlet 114b.

The feeding section 111, the pre-heating sections 112, the heating sections 113, and the discharging sections 114 are in space connection with one another and form a transportation space TPS. The twin-screw 120 are rotatably disposed in the transportation space TPS and driven by, for example, a conveyor motor MT1, so that the twin-screw 120 are able to continuously transport the object OBJ within the transportation space TPS. Please note that the twin-screw 120 have relatively low requirements regarding the types or specifications of the object OBJ to be transported, allowing the heating apparatus 10 to be adaptable for the thermal decomposition of a variety of objects (OBJ). On the contrary, in traditional single screw, the object needs to completely fill the space adjacent to the single screw, in order to generate a sufficient pressure to push the object forward.

The feeding hopper 200 can be in space connection with the feeding section 111 via the feeding port 111a, and the feeding hopper 200 may be, for example, connected to a feeding motor MT2 for assistance in feeding. The intake pipe 300 can be in space connection with the feeding section 111 via the gas inlet 111b. The feeding hopper 200 and the intake pipe 300 can be disposed on the feeding section 111 to form a feeding and intake module M1. Please note that in some embodiments of the present disclosure, the number of the feeding section may be multiple, and the plurality of feeding sections can be detachably assembled with each other, and the feeding hopper and the intake pipe may be respectively disposed on and in space connection with different feeding sections and may be respectively form a feeding module and an intake module, each with its respective feeding sections.

The preheaters 400 may be directly disposed on the pre-heating sections 112. The preheaters 400 may include a medium that can be used to generate heat, such as an electric heat pipe or thermal oil, such that the preheater 400 can provide, for example, heat radiation to the pre-heating sections 112. The preheaters 400 may be disposed on an inner side or an outer side of the barrel 110, and the present disclosure is not limited thereto.

One preheater 400 and one pre-heating section 112 can be disposed on each other and together form a pre-heating module M2. The number of the preheaters 400 is the same as the number of the pre-heating sections 112, and the total amount of each of the preheaters 400 and the pre-heating sections 122 in each pre-heating module M2 is one. Please note that in some embodiments of the present disclosure, there may be only one preheater and only one pre-heating section, and thus only one pre-heating module would be formed. Please note in some embodiments of the present disclosure, multiple preheaters may be disposed on multiple sides of the pre-heating section, such that the number of the preheaters and the pre-heating sections in a pre-heating module may be multiple, rather than just one.

Each microwave generation device 500 may include a plurality of waveguides 510 and a plurality of microwave heaters 520. The waveguides 510 are directly disposed on the heating sections 113 of the barrel 110. The microwave heaters 520 are directly disposed on the sides of the waveguides 510, farther from the barrel 110, and the microwave heaters 520 apply microwaves to the heating sections 113 through the waveguides 510. Moreover, the heating sections 113 may have microwave transmission interfaces (not numbered) on the sides near the waveguides 510, thereby facilitating the transmission of microwaves applied by the microwave generation devices 500. Moreover, the microwave transmission interfaces may be made of, for example, polytetrafluoroethylene (commonly known as Teflon), ceramic, quartz, or other non-metallic materials that do not reflect microwaves.

One waveguide 510, one microwave heater 520 and one heating section 113 can be arranged to form a microwave module M3. The number of the waveguides 510, the number of the microwave heaters 520 and the number of the heating sections 113 are the same, and the total amount of each of the waveguides 510, the microwave heaters 520 and the heating sections 113 in each microwave module M3 is one. Please note that in some embodiments of the present disclosure, there may be only one waveguide, only one microwave heater and only one heating section in total, and thus only one microwave module would be formed. Please note that in some embodiments of the present disclosure, multiple waveguides and multiple microwave heaters may be arranged on multiple sides of the heating section, such that the number of the waveguides, the number of the microwave heaters and the number of the heating sections may be multiple, rather than just one.

Moreover, the discharging section 114 having the discharging port 114a forms a discharging module M4, while the discharging section 114 having the gas outlet 114b forms an exhausting module M5. Please note that in some embodiments of the present disclosure, there may be only one discharging section having both the discharging port and the gas outlet, and thus only one discharging and exhausting module would be formed.

In the following, an operating method of the heating apparatus 10 is illustrated. The heating apparatus 10 may gather an object OBJ through the feeding hopper 200, and the object OBJ may enter the feeding section 111 via the feeding port 111a. Moreover, the heating apparatus 10 may use the intake pipe 300 to introduce inert gas (not shown) such as nitrogen and noble gas into the transportation space TPS via the gas inlet 111b.

Then, the heating apparatus 10 may transport the object OBJ from the feeding section 111 to the pre-heating sections 112 through the twin-screw 120. The preheater 400 may be in thermal contact with the object OBJ transported to the pre-heating sections 112 to preheat the object OBJ.

Then, the heating apparatus 10 may continue to transport the object OBJ from the pre-heating sections 112 to the heating sections 113 through the twin-screw 120. The microwave generation device 500 may apply microwaves to the object OBJ transported to the heating sections 113 for heating and decomposing the object OBJ into the at least one product.

Then, the heating apparatus 10 may continue to transport the object OBJ from the heating sections 113 to the discharging sections 114 through the twin-screw 120, such that the at least one product in solid form or fluid form may be extruded from the transportation space TPS via the discharging port 114a, and the at least one product in gaseous form may be discharged from the transportation space TPS via the gas outlet 114b. The at least one product extruded or discharged from the transportation space TPS may be recycled and reused. Please note that the at least one product generated during the decomposition of the object OBJ have been decomposed into small molecules, which exhibit increased reactivity for combustion with oxygen in the high-temperature transportation space TPS. Therefore, the inert gas introduced into the transportation space TPS via the intake pipe 300 and the gas inlet 111b, as mentioned above, helps suppress potential risks of such combustion reactions.

In the present disclosure, a heating reaction method uses the microwave generation device 500 to apply microwaves to the object OBJ in the heating sections 113, facilitating heat transfer outwards from the inner side of the object OBJ. Unlike conventional methods that transfer heat inwards from the outer side of an object, the heating reaction method of the present disclosure ensures that the object OBJ quickly reaches a target temperature, such as the temperature at which thermal decomposition begins, thereby effectively achieving the continuous high-temperature reaction.

Moreover, compared to conventional methods that transfer heat inwards from the outer side of an object, the heating reaction method of the present disclosure requires the barrel 110 with lower heat resistance and offers higher heating efficiency for the object OBJ, achieving a reduction in manufacturing and operation costs, as well as a reduction in the overall length of the heating apparatus 10.

Moreover, with the design of the feeding and intake module M1, the pre-heating modules M2, the microwave modules M3, the discharging module M4 and the exhausting module M5, it is favorable to increase or decrease the number of each module based on the characteristics of the object OBJ to be heated or other usage requirements. This allows for the adjustment of the overall length of the transportation space TPS and, consequently, the adjustment of the size of the heating apparatus 10. Also, this design enables the heating apparatus 10 to be easily disassembled, ensuring convenience for transportation. Additionally, the design of the microwave module M3 ensures that a specific number of microwave heater(s) 520 corresponds to only one heating section 113, allowing each heating section 113 to receive evenly distributed microwaves. This enables the temperature of the object OBJ to rise uniformly, thereby facilitating precise temperature control of the heating apparatus 10. Furthermore, in some cases, the power of the microwave heater 520 in each microwave module M3 can be adjusted according to actual requirements, such as gradually increasing the power of the microwaves applied to the object OBJ.

Moreover, preheating the object OBJ by the preheater 400 before receiving microwaves can reduce the time required for the object OBJ to reach the target temperature uniformly, both internally and externally. In some cases, preheating the object OBJ by the preheater 400 can slightly melt the object OBJ, which facilitates the transportation of the object OBJ using the twin-screw 120. Please note that in some embodiments of the present disclosure, the object may not be preheated from outside before receiving microwaves, or the object may be heated to be slightly melt by any suitable manner before entering the transportation space, allowing the omission of the pre-heating sections and the preheaters. In some embodiments of the present disclosure, the pre-heating module can be easily and simply disassembled to remove the pre-heating sections and the preheaters in the heating apparatus.

In some other embodiments of the present disclosure, the object may include a microwave absorber to facilitate microwave absorption for more efficiently generating heat from the inner side when exposed to microwaves.

In some other embodiments of the present disclosure, if the at least one product generated during the thermal decomposition of the object does not pose risks such as combustion reactions with oxygen, the introduction of inert gas may not be necessary, allowing related components such as the gas inlet and the intake pipe can be omitted.

In some other embodiments of the present disclosure, the feeding hopper may be replaced with other suitable mechanisms, such as robotic arms or conveyor belts.

In some other embodiments of the present disclosure, the feeding port and the gas inlet may be integrated into a single opening.

In some other embodiments of the present disclosure, the discharging port and the gas outlet may be integrated into a single opening.

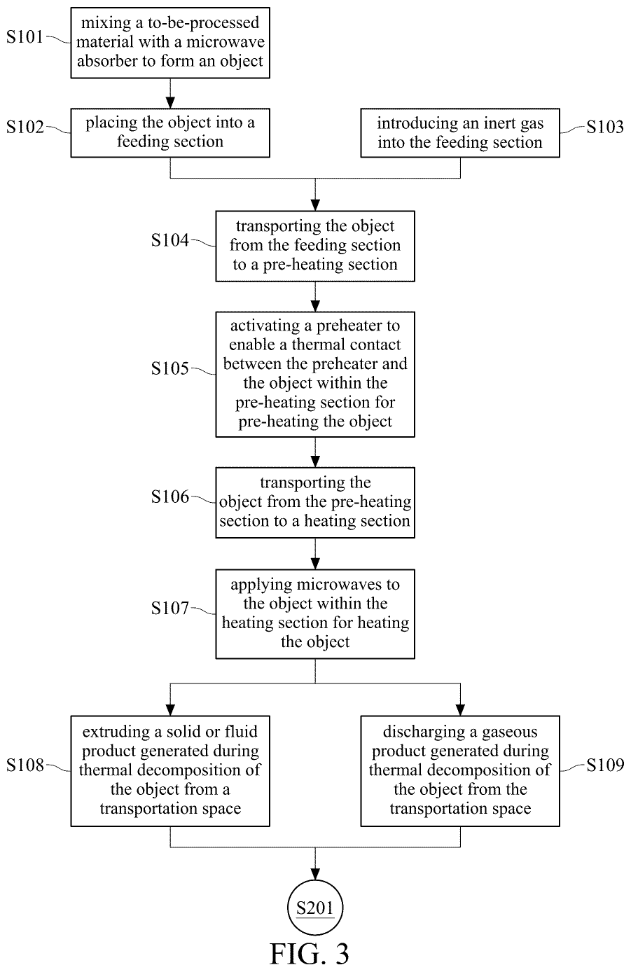

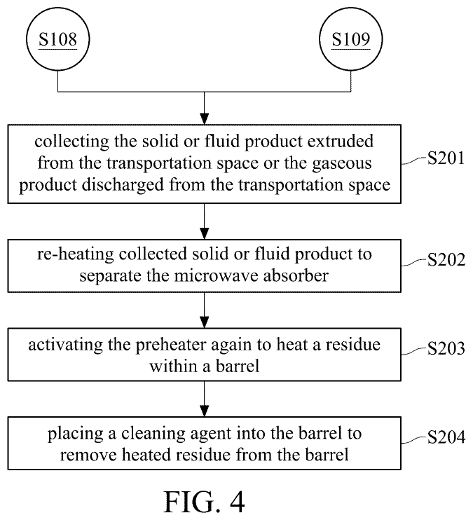

In the following, a heating reaction method according to one embodiment of the present disclosure is illustrated. Please refer to FIG. 3 to FIG. 4 together with FIG. 1 to FIG. 2, where FIG. 3 and FIG. 4 are flow charts of a heating reaction method according to one embodiment of the present disclosure.

As shown in FIG. 3, the heating reaction method implemented using the heating apparatus 10 can include step S101 to step S109.

In step S101, a to-be-processed material (not shown) can be mixed with a microwave absorber (not shown) to form an object OBJ. In some embodiments of the present disclosure, the addition of the microwave absorber may not be necessary. If no microwave absorber is required, step S101 may be omitted in these embodiments, and the abovementioned to-be-processed material can be directly used as the object. In some other embodiments of the present disclosure, the number of the feeding hopper may be multiple. In the cases that the number of the feeding hoppers is multiple, step S101 may be omitted in these cases, and the to-be-processed material and the microwave absorber can be respectively placed into separate feeding hoppers for proper mixing in the subsequent process.

In step S102, the object OBJ can be placed into the feeding section 111 of the barrel 110 via the feeding hopper 200 and the feeding port 111a.

In step S103, an inert gas (not shown) can be introduced into the feeding section 111 of the barrel 110 via the intake pipe 300 and the gas inlet 111b. As mentioned above, in some embodiments of the present disclosure, the gas inlet and the intake pipe may be omitted. In the cases that the gas inlet and the intake pipe are omitted, step S103 may be omitted in these embodiments.

Please note that step S101 and step 103 can be processed simultaneously or sequentially, and the present disclosure is not limited thereto.

Then, in step S104, the object OBJ can be transported from the feeding section 111 of the barrel 110 to the pre-heating sections 112 of the barrel 110 through the twin-screw 120.

Then, in step S105, the preheater 400 can be activated to heat the pre-heating sections 112 of the barrel 110, enabling a thermal contact between the preheater 400 and the object OBJ within the pre-heating sections 112. As such, the outermost temperature of the object OBJ can be raised to, for example, a temperature ranging from 150° C. to 250° C. Please note that the activation of the preheater 400 in step S105 may be performed before step S104, and the present disclosure is not limited thereto.

Then, in step S106, the object OBJ can be transported from the pre-heating sections 112 of the barrel 110 to the heating sections 113 of the barrel 110 through the twin-screw 120. As mentioned above, in some embodiments of the present disclosure, the pre-heating sections and the preheaters may be omitted. In the cases that the pre-heating sections and the preheaters are omitted, step S104 and step S105 may be omitted in these embodiments, and the object is directly transported from the feeding section to the heating sections in step S106.

Then, in step S107, the microwave generation devices 500 can be used to apply microwaves to the object OBJ within the heating sections 113 under the operating conditions of a microwave power ranging from 100 watts (W) to 2000 W, a microwave frequency ranging from 400 megahertz (MHz) to 2450 MHz and a reaction temperature ranging from 250° C. to 1000° C. As such, the object OBJ is heated to, for example, an outermost temperature ranging from 250° C. to 450° C. and an innermost temperature ranging from 350° C. to 550° C.

Then, in step S108, at least one product, which is present in solid form or fluid form and is generated during the thermal decomposition of the object OBJ, can be extruded by the twin-screw 120 from the transportation space TPS of the barrel 110 via the discharging port 114a (the discharging module M4).

In step S109, at least one product, which is present in gaseous form and is generated during the thermal decomposition of the object OBJ, can be discharged from the transportation space TPS of the barrel 110 via the gas outlet 114b (the exhausting module M5).

Please note that throughout step S101 to step S109, the internal pressure within the transportation space TPS of the barrel 110 can range from 0.1 megapascals (MPa) to 2 MPa.

Then, as shown in FIG. 4, the heating reaction method implemented using the heating apparatus 10 can further include step S201 to step S204.

In step S201, a collection device (not shown) can be used to collect the at least one product extruded or discharged from the transportation space TPS. The at least one product obtained by the heating reaction method using the heating apparatus may undergo different post-processing treatments for use in various applications. For example, there may be a case that an organic matter such as plastic needs to be thermally decomposed into reusable small molecules or reusable oligomer materials. Under this circumstance, solid organic products generated during the thermal decomposition can be extruded via the discharging port 114a and be collected by the collection device, while gaseous products, as byproducts generated during the thermal decomposition, can be discharged via the gas outlet 114b for subsequent waste treatment. In another example, there may be another case to recover oils from the object for reuse as fuel. Under this circumstance, oil vapors generated during the thermal decomposition can be discharged via the gas outlet 114b and be collected by the collection device for condensing the oil vapors into liquid form or further purifying the condensed oil, while the remaining thermal decomposed solid or fluid byproducts can be extruded via the discharging port 114a for subsequent waste treatment.

Then, in step S202, the collected solid or fluid product can be re-heated to separate the microwave absorber. Since microwave absorbers are generally composed of high-decomposition-temperature materials, such as carbon black, they may not be fully decomposed during step S107. Therefore, step S202 can be carried out to further purify the collected solid or fluid product. Please note that the purification of the collected solid or fluid product in step S202 can be performed by another simple heating device instead of the heating apparatus 10 since the collected solid or fluid product is already purified once during the thermal decomposition in the heating apparatus 10. In some embodiments of the present disclosure, there may be a case that only gaseous products generated from the thermally decomposed object need to be collected. In the case that only gaseous products from the thermal decomposition need to be collected, step S202 may be omitted in these embodiments.

Then, in step S203, the preheater 400 can be activated again to heat a residue (not shown) within the barrel 110.

Then, in step S204, a cleaning agent (not shown) can be placed into the barrel 110 to assist in removal of the heated residue from the transportation space TPS of the barrel 110. Considering that the residue may not be easily softened under microwave heating, the residue can be heated by the preheater 400 and can be carried out of the transportation space TPS of the barrel 110 by the cleaning agent. As mentioned above, in some embodiments of the present disclosure, the addition of the microwave absorber may not be necessary. In the cases that no microwave absorber is required, step S202 to step S204, or only step S202 to step S203, may be omitted in these embodiments.

Please refer to Table 1, which compares the temperature variations of objects heated using the heating reaction method according to one embodiment of the present disclosure and conventional electric heating methods. In this comparison, all objects have a total weight of 20 grams and are heated until their innermost temperature reaches 550° C. In the embodiment of the present disclosure, microwaves with a power of 600 W are applied to heat an object OBJ containing 10% carbon black as a microwave absorber. In contrast, Comparative Example 1 uses a conventional electric furnace set to 650° C. to heat an object containing 10% magnesium-aluminum oxide as a thermal conductor, while Comparative Example 2 uses a conventional electric furnace set to 650° C. to heat an object without any thermal conductor. Please note that the object OBJ in the embodiment of the present disclosure and objects in Comparative Examples 1-2 may be polystyrene (PS).

TABLE 1

| | Embodiment | | |
|---|---|---|---|
| | of the present | Comparative | Comparative |
| Object | disclosure | Example 1 | Example 2 |
| Time | Temperature | Temperature | Temperature |
| (min) | (° C.) | (° C.) | (° C.) |
| 1 | 155 | 42 | 39 |
| 5 | 445 | 101 | 52 |
| 6.5 | 589 | 124 | 60 |
| 10 | — | 193 | 82 |
| 20 | — | 392 | 156 |
| 27.5 | — | 589 | 249 |
| 40 | — | — | 402 |
| 52 | — | — | 593 |
| Heating | 168.3 | 21.4 | 11.4 |
| Rate | | | |
| (° C./min) | | | |

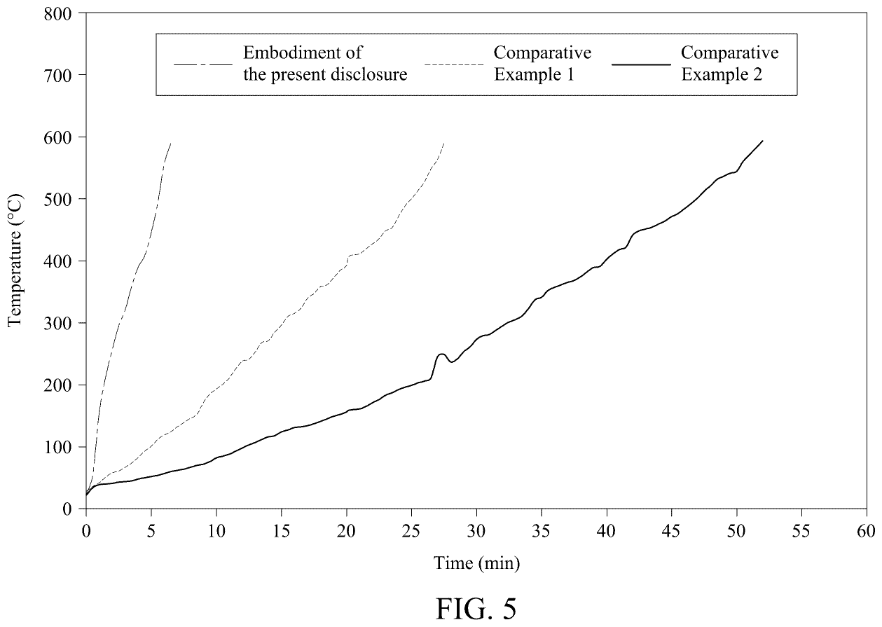

The results in Table 1 are graphically depicted in FIG. 5, where FIG. 5 is a line chart comparing heating rates of a heating reaction method according to one embodiment of the present disclosure and a conventional electric heating method. In FIG. 5, the horizontal axis represents heating time (minutes, min), while the vertical axis represents the innermost temperature (° C.) of the heated objects.

The heating reaction method of one embodiment of the present disclosure applies microwaves to the object OBJ, allowing heat to efficiently transfer outwards from the inner side of the object OBJ. This enables the object OBJ to quickly reach the target temperature, with its innermost temperature rising to 550° C. In contrast, in the Comparative Examples 1 and 2, the heat from the electric heaters (e.g., electric heat pipes) transfers inwards from the outermost side of the object, leading to potential heat loss during transportation and thus resulting in poor heat transfer efficiency. Furthermore, the methods in the Comparative Examples 1 and 2 require reactors (e.g., barrels) to withstand temperatures higher than the target temperature (e.g., 650° C. or more). Moreover, as shown in FIG. 5, the heating rate of the heating reaction method in one embodiment of the present disclosure is 8 to 15 times faster than that of the electric heating method used in the Comparative Examples 1 and 2.

Please refer to Table 2 to Table 4, which compare the heating reaction methods of the first to twelfth embodiments (EM1 to EM12) of the present disclosure with the conventional electric heating methods used in Comparative Examples 3 to 4. In these tables, PMMA refers to poly(methyl methacrylate), PS refers to polystyrene, ABS refers to acrylonitrile butadiene styrene, and epoxy resin/glass fiber refers to object material derived from printed circuit boards (PCBs).

TABLE 2

| | Comparative | Comparative | | | |
|---|---|---|---|---|---|
| Experiment | Example 3 | Example 4 | EM1 | EM2 | EM3 |
| Object Type | Plastic | Plastic | Plastic | Plastic | Plastic |
| Object | PMMA | PS | PMMA | PMMA | PMMA |
| Material | | | | | |

Processing Parameters

| Heating Type | Electric | | Electric | | Microwave | | Microwave | | Microwave | |
|---|---|---|---|---|---|---|---|---|---|---|
| | Heating | | Heating | | Heating | | Heating | | Heating | |
| Microwave | N/A | | N/A | | 100 | W | 800 | W | 1000 | W |
| Power | | | | | | | | | | |
| Number of | N/A | | N/A | | 1 | | 2 | | 3 | |
| Microwave | | | | | | | | | | |
| Modules | | | | | | | | | | |
| Percentage of | N/A | | N/A | | 10% | | 10% | | 10% | |
| Microwave | | | | | | | | | | |
| Absorber | | | | | | | | | | |
| Reactor | 1.0 | Mpa | 1.0 | Mpa | 1.0 | Mpa | 1.0 | Mpa | 1.0 | Mpa |
| Internal | | | | | | | | | | |
| Pressure | | | | | | | | | | |
| Reactor | 350° | C. | 350° | C. | 200° | C. | 350° | C. | 450° | C. |
| Outermost | | | | | | | | | | |
| Temperature | | | | | | | | | | |

Processing Efficiency

| | | | | | |
|---|---|---|---|---|---|
| Conversion | 0.0% | 0.0% | 44.3% | 80.1% | 90.3% |
| Rate | | | | | |

TABLE 3

| Experiment | EM4 | EM5 | EM6 | EM7 | EM8 |
|---|---|---|---|---|---|
| Object Type | Plastic | Plastic | Plastic | Plastic | Plastic |
| Object | PMMA | PMMA | PMMA | PMMA | PMMA |
| Material | | | | | |

Processing Parameters

| Heating Type | Microwave | | Microwave | | Microwave | | Microwave | | Microwave | |
|---|---|---|---|---|---|---|---|---|---|---|
| | Heating | | Heating | | Heating | | Heating | | Heating | |
| Microwave | 800 | W | 800 | W | 1000 | W | 1000 | W | 1000 | W |
| Power | | | | | | | | | | |
| Number of | 2 | | 2 | | 2 | | 2 | | 2 | |
| Microwave | | | | | | | | | | |
| Modules | | | | | | | | | | |
| Percentage of | 10% | | 10% | | 10% | | 20% | | 20% | |
| Microwave | | | | | | | | | | |
| Absorber | | | | | | | | | | |
| Reactor | 0.1 | Mpa | 2.0 | Mpa | 1.0 | Mpa | 1.0 | Mpa | 1.0 | Mpa |
| Internal | | | | | | | | | | |
| Pressure | | | | | | | | | | |
| Reactor | 350° | C. | 350° | C. | 400° | C. | 500° | C. | 600° | C. |
| Outermost | | | | | | | | | | |
| Temperature | | | | | | | | | | |

Processing Efficiency

| | | | | | |
|---|---|---|---|---|---|
| Conversion | 83.2% | 87.4% | 91.8% | 95.6% | 98.6% |
| Rate | | | | | |

TABLE 4

| Experiment | EM9 | EM10 | EM11 | EM12 |
|---|---|---|---|---|
| Object | Plastic | Plastic | Organic / | Biomass |
| Type | | | Inorganic | |
| | | | Composite | |
| Object | PS | ABS | Epoxy Resin / | Lignin |
| Material | | | Glass Fiber | |

Processing Parameters

| Heating | Microwave | | Microwave | | Microwave | | Microwave | |
|---|---|---|---|---|---|---|---|---|
| Type | Heating | | Heating | | Heating | | Heating | |
| Microwave | 800 | W | 800 | W | 800 | W | 800 | W |
| Power | | | | | | | | |
| Number of | 2 | | 2 | | 2 | | 2 | |
| Microwave | | | | | | | | |
| Modules | | | | | | | | |
| Percentage | 10% | | 10% | | 10% | | 10% | |
| of | | | | | | | | |
| Microwave | | | | | | | | |
| Absorber | | | | | | | | |
| Reactor | 1.0 | Mpa | 1.0 | Mpa | 1.0 | Mpa | 1.0 | Mpa |
| Pressure | | | | | | | | |
| Reactor | 350° | C. | 350° | C. | 350° | C. | 350° | C. |
| Outermost | | | | | | | | |
| Temperature | | | | | | | | |

Processing Efficiency

| | | | | |
|---|---|---|---|---|
| Conversion | 77.4% | 70.3% | 75.0% | 64.0% |
| Rate | | | | |

As shown in Table 2, the outermost temperatures of the reactors in the Comparative Examples 3 and 4 reach only 350° C. Since the heat from the electric heaters is transferred inwards from the outer side of the objects, the innermost temperatures of the objects in the Comparative Examples 3 and 4 can be deduced to be lower than 350° C., failing to reach the temperature at which thermal decomposition begins. As a result, the conversion rates thereof are 0.0%. As shown in Table 2, the first to second embodiments show that increments in both the microwave power and the number of the microwave module raise the outermost temperature of the reactor, thereby improving the conversion rate. As shown in Table 2, the second to third embodiments show that a further increment in microwave power and the number of the microwave module further promotes the outermost temperature of the reactor, leading to an even higher conversion rate.

As shown in Table 3, the fourth and fifth embodiments respectively show a reduction and an increase in reactor internal pressure compared to the second embodiment, resulting in a conversion rate that is roughly similar (considering experimental error) and an improved conversion rate, respectively. As shown in Table 3, the sixth embodiment shows slight reductions in both the number of the microwave module and the reactor outermost temperature compared to the third embodiment, resulting in a conversion rate that is substantially maintained (considering experiment error). As shown in Table 3, the seventh and eighth embodiments show increments in both microwave absorber percentage and reactor outermost temperature, leading to higher conversion rates.

As shown in Table 4, the ninth to twelfth embodiments performed heating reactions on different types of objects under operation conditions similar to those in the second embodiment, achieving favorable conversion rates.

According to the heating reaction method discussed above, applying microwaves to the object in the heating sections using the microwave generation device allows heat to transfer outwards from the inner side of the object. Unlike conventional methods that transfer heat inwards from the outer side, the heating reaction method of the present disclosure ensures that the object rapidly reaches a target temperature, such as the temperature at which thermal decomposition begins, thereby effectively achieving continuous high-temperature reaction.

Moreover, compared to conventional methods that transfer heat inwards from the outer side of an object, the heating reaction method of the present disclosure requires less heat resistance from the barrel and offers higher heating efficiency for the object, reducing manufacturing and operational costs, along with decreasing the overall length of the heating apparatus.

Additionally, preheating the object with the preheater before exposing it to microwaves can reduce the time needed for the object to reach a uniform target temperature, both internally and externally. In some cases, preheating the object by the preheater can cause slightly melting of the object, which helps facilitate the transportation of the object by the twin-screw.

Furthermore, with the design of the feeding and intake module, the pre-heating modules, the microwave modules, the discharging module and the exhausting module, it is possible to adjust the number of each module based on the characteristics of the object to be heated or other specific requirements. This flexibility allows for the modification of the overall length of the transportation space and, consequently, the size of the heating apparatus. Additionally, this design enables the heating apparatus to be easily disassembled for convenient transportation. Further, the design of the microwave module ensures that a specific number of microwave heater(s) corresponds to only one heating section, allowing each heating section to receive evenly distributed microwaves. This enables the temperature of the object to rise uniformly, thereby facilitating precise temperature control of the heating apparatus. Furthermore, in some cases, the power of the microwave heater in each microwave module can be adjusted according to actual requirements, such as gradually increasing the power of the microwaves applied to the object.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A heating reaction method comprising:
placing an object into a barrel of a twin-screw extruder;
transporting the object from a feeding section of the barrel to a heating section of the barrel using a twin-screw of the twin-screw extruder;
applying microwaves to the object within the heating section using a microwave generation device for heating and decomposing the object into at least one product; and
discharging the at least one product from the barrel using the twin-screw.

2. The heating reaction method as claimed in claim 1, wherein before applying the microwaves to the object using the microwave generation device, the method further comprises:
transporting the object from the feeding section of the barrel to a pre-heating section of the barrel using the twin-screw; and
activating a preheater to enable a thermal contact between the preheater and the object within the pre-heating section for pre-heating the object.

3. The heating reaction method as claimed in claim 1, wherein before applying the microwaves to the object using the microwave generation device, the method further comprises:
introducing an inert gas into the feeding section of the barrel.

4. The heating reaction method as claimed in claim 1, wherein after applying the microwaves to the object using the microwave generation device, the method further comprises:
discharging the at least one product from the barrel, wherein the at least one product is present in gaseous form.

5. The heating reaction method as claimed in claim 1, wherein before placing the object into the barrel, the method further comprises:
mixing a to-be-processed material with a microwave absorber to form the object.

6. The heating reaction method as claimed in claim 5, wherein after discharging the at least one product from the barrel using the twin-screw, the method further comprises:
re-heating the at least one product for separating the microwave absorber.

7. The heating reaction method as claimed in claim 1, wherein after discharging the at least one product from the barrel using the twin-screw, the method further comprises:
activating a preheater to heat a residue inside the barrel; and
placing a cleaning agent into the barrel to discharge the residue from the barrel.

8. The heating reaction method as claimed in claim 1, wherein applying the microwaves to the object using the microwave generation device comprises:
applying the microwaves to the object using the microwave generation device with a microwave power ranging from 100 watts to 2000 watts and a microwave frequency ranging from 400 MHz to 2450 MHz.

9. The heating reaction method as claimed in claim 1, wherein applying the microwaves to the object using the microwave generation device comprises:
applying the microwaves to the object using the microwave generation device with a reaction temperature ranging from 250° C. to 1000° C.

10. The heating reaction method as claimed in claim 1, wherein the barrel has an internal pressure ranging from 0.1 MPa to 2 MPa.

11. A heating apparatus comprising:
a twin-screw extruder comprising:
a barrel having at least one feeding section, at least one heating section and at least one discharging section that are sequentially arranged, wherein the at least one feeding section, the at least one heating section and the at least one discharging section are in space connection with one another and form a transportation space; and
a twin-screw rotatably disposed in the transportation space; and
a microwave generation device comprising:
a waveguide directly disposed on the at least one heating section of the barrel; and
a microwave heater directly disposed on a side of the waveguide farther from the barrel, wherein the microwave heater applies microwaves to the at least one heating section through the waveguide.

12. The heating apparatus as claimed in claim 11, wherein a number of the at least one heating section is multiple, a number of the waveguide is multiple, a number of the microwave heater is multiple, the heating sections are detachably assembled with each other, the heating sections are detachably disposed between the at least one feeding section and the at least one discharging section, and one of the heating sections, one of the waveguides and one of the microwave heaters are arranged to form a microwave module.

13. The heating apparatus as claimed in claim 11, further comprising a preheater, wherein the barrel further has at least one pre-heating section detachably disposed between and in space connection with the at least one feeding section and the at least one heating section, and the preheater is disposed on the at least one pre-heating section.

14. The heating apparatus as claimed in claim 13, wherein a number of the at least one pre-heating section is multiple, a number of the preheater is multiple, the pre-heating sections are detachably assembled with each other, and one of the pre-heating sections and one of the preheaters are arranged to form a pre-heating module.

15. The heating apparatus as claimed in claim 11, further comprising a feeding hopper, wherein the at least one feeding section has a feeding port, and the feeding hopper is in space connection with the at least one feeding section via the feeding port.

16. The heating apparatus as claimed in claim 11, further comprising an intake pipe, wherein the at least one feeding section has a gas inlet, the intake pipe is in space connection with the at least one feeding section via the gas inlet, and the intake pipe is configured for an inert gas to be introduced into the transportation space via the gas inlet.

17. The heating apparatus as claimed in claim 16, wherein the at least one feeding section and the intake pipe are arranged to form a feeding and intake module.

18. The heating apparatus as claimed in claim 11, wherein the at least one discharging section has a discharging port and a gas outlet, and at least one of the discharging port and the gas outlet is configured to discharge or extrude at least one product generated from an object subjected to heating and decomposition within the transportation space.

19. The heating apparatus as claimed in claim 18, wherein a number of the at least one discharging section is multiple, the discharging sections are detachably assembled with each other, the discharging sections are detachably disposed on a side of the at least one heating section farther from the at least one feeding section, one of the discharging sections has the discharging port, another one of the discharging sections has the gas outlet, the one of the discharging sections having the discharging port forms a discharging module, and the another one of the discharging sections having the gas outlet forms an exhausting module.

20. The heating apparatus as claimed in claim 11, wherein the at least one heating section of the barrel has a microwave transmission interface on a side thereof near the waveguide for facilitating transmission of microwaves applied by the microwave generation device.
